(19) United States
(12) Patent Application Publication
(10) Pub. No.: US 2026/0150012 A1
(43) Pub. Date: May 28, 2026

(54) METHODS AND APPARATUS FOR HANDLING SUCCESSFUL PRIMARY AND SUCCESSFUL PSCELL REPORT (SPR) IN WIRELESS NETWORK

(71) Applicant: Samsung Electronics Co., Ltd., Suwon-si, Gyeonggi-do (KR)

(72) Inventor: Aby Kanneath ABRAHAM, Bangalore (IN)

(21) Appl. No.: 19/124,056

(22) PCT Filed: Oct. 27, 2023
(86) PCT No.: PCT/KR2023/016909

§ 371 Date: Apr. 24, 2025

(30) Foreign Application Priority Data
Oct. 27, 2022 (IN) 202241061308
Oct. 4, 2023 (IN) 2022 41061308

(51) Int. Cl. H04W 36/00

(52) U.S. Cl. CPC H04W 36/0058; H04W 36/0069

(57) ABSTRACT

This disclosure relates to a method performed by a terminal in a communication system, the method comprising: receiving, from a base station, a message comprising information on a configuration for the terminal to report successful primary secondary cell (PSCell) addition or PSCell change information; identifying whether at least one of condition is met; and in case that the at least one of the condition is met, releasing the configuration.

### TECHNICAL FIELD

Embodiments disclosed herein relate to wireless communication network (or wireless network), more particularly to methods and the wireless network for self-optimization of primary cell of a secondary cell group (PSCell) change and PSCell addition in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

Currently, New Generation Radio Access Network (NG-RAN) supports a Multi-Radio Dual Connectivity (MR-DC) operation in which a user equipment (UE) in a radio resource control (RRC) CONNECTED is configured to utilize radio resources provided by two distinct schedulers, located in two different NG-RAN nodes connected via a non-ideal backhaul-one NG-RAN node provides NR (New Radio) access and the other NG-RAN node provides either E-UTRA (Evolved UMTS Terrestrial Radio Access) or new radio (NR) access. One NG-RAN node act as a master node (MN) and the other NG-RAN node as a secondary node (SN). The MN and SN are connected together via a network interface and at least the MN is connected to a core network. The NG-RAN supports a NG-RAN E-UTRA-NR Dual Connectivity (NGEN-DC), in which a User Equipment (UE) is connected to one NG-eNB (a E-UTRA base station that can connect to a 5G core) that acts as the MN and one gNB (e.g., 5G base station) that acts as the SN. The NG-RAN also supports NR-E-UTRA Dual Connectivity (i.e., NE-DC), in which the UE is connected to one gNB that acts as the MN and one ng-eNB that acts as the SN. A PSCell is a primary cell for a Secondary Cell Group (SCG) whereas a PCell is the primary cell of a Master Cell Group.

The PSCell change can occur due to mobility and may or may not be associated with a secondary node change (SN change). A secondary node change procedure is initiated either by the MN or the SN and used to transfer a UE context from a source SN to a target SN and to change the SCG configuration in the UE from one SN to another SN.

A Conditional PSCellChange (CPC) is defined as a PSCell Change that is executed by the UE when execution condition(s) is met. The UE may be configured with execution condition and a radio resource control (RRC) message like RRC Reconfiguration for executing when the conditions are met for one or more of candidate cells. The UE starts evaluating the execution condition(s) upon receiving a CPC configuration, and stops evaluating the execution condition(s) once PSCellChange is triggered. An intra-SN CPC without MN involvement and inter-SN CPC initiated either by the MN or the SN are supported.

The following principles apply to the CPC, the CPC configuration contains the configuration of CPC candidate PSCell(s) and execution condition(s) and may contain the MN configuration for inter-SN CPC. An execution condition may consist of one or two trigger condition(s) (such as CPC events A3/A5, as defined in technical specification (TS) 38.331). Only single Reference Signal (RS) type is supported and at most two different trigger quantities (e.g., Reference Signal Received Power (RSRP) and Reference Signal Received Quality (RSRQ), RSRP and Signal to Interference & Noise Ratio (SINR), etc.) can be configured simultaneously for the evaluation of CPC execution condition of a single candidate PSCell. Before any CPC execution condition is satisfied, upon reception of PSCellChange command or PCell change command, the UE executes the PSCellChange procedure, regardless of any previously received CPC configuration. In NR release 17 specifications, upon the successful completion of PSCellChange procedure or PCellChange procedure, the UE releases all stored CPC configurations.

While executing the CPC, the UE is not required to continue evaluating the execution condition of other candidate PSCell(s). Once the CPC procedure is executed successfully, the UE releases all stored CPC configurations. Upon the release of SCG, the UE releases the stored CPC configurations. A Third Generation Partnership Project (3GPP) release 18 enhances the CPC through selective activation of cell groups where the UE doesn't release the stored CPC configuration for one or more candidate PS Cells and the source PSCell based on network's inputs. MN adds PSCell during a PSCellAddition procedure. A PSCellAddition procedure that is executed only when the PSCellAddition condition(s) are met is called Conditional PSCellAddition (CPA). There needs to have a mechanism for performing the self-optimization and minimization of drive tests for PSCellChange and PSCellAddition including CPC and CPA.

It is desired to address the above mentioned disadvantages or other short comings or at least provide a useful alternative.

### DISCLOSURE OF INVENTION

### Technical Problem

In line with development of the communication systems, there is a need for handling successful primary and Successful PSCell Report (SPR) in wireless network.

The principal object of the embodiments herein is to disclose methods and a UE for handling a SPR in a wireless network.

Another object of the embodiments herein is to release a SPR configuration in the wireless network.

Another object of the embodiments herein is to release SPR in the wireless network.

Another object of the embodiments herein is to handle overwrite issue of SPR, for e.g. by reporting an availability of SPR through UEAssistanceInformation RRC message in the wireless network.

Another object of the embodiments herein is to configure, report and release the configuration of UE for reporting information related to successful PS cell addition and change in the wireless network.

Another object of the embodiment herein is to store and report a successful PS Cell Report (SPR) in the wireless network.

Another object of the embodiment herein is to configure the UE to report the information separately in different reports for successful PSCell Addition or Successful PSCell change report in the wireless network.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

Accordingly, the embodiments herein discloses methods for handling a successful primary and Successful PSCell Report (SPR) in a wireless network. The method includes receiving, by a UE, a SPR configuration from a network entity in the wireless network. Further, the method includes detecting, by the UE, a first event. The first event includes one of: initiation of a radio resource control (RRC) reestablishment procedure, initiation of a RRC resume procedure, a Secondary Cell Group (SCG) failure, a change of a primary cell (PCell) due to a handover procedure, a Lower Layer Triggered Mobility (LTM) at the PCell (i.e. Lower Layer Triggered mobility from one PCell to another), a SCG release, a successful PSCell change, a successful PSCell addition, a successful PSCell change with conditions for the SPR are fulfilled, and a successful PSCell addition with conditions for the SPR are fulfilled. In an embodiment, the method includes logging the SPR upon detecting one of the successful PSCell change with the conditions for the SPR are fulfilled, and the successful PSCell addition with the conditions for the SPR are fulfilled based on the detected first event. In another embodiment, the method includes releasing the SPR configuration upon detecting one of: the RRC reestablishment procedure, the RRC resume procedure, the SCG failure, the change of the PCell due to the handover procedure, the LLTM at the PCell, the SCG release a successful PSCell change, and the Successful PSCell addition based on the detected first event.

In an embodiment, after storing the SPR upon determining one of: the successful PSCell change with the conditions for the SPR are fulfilled and the successful PSCell addition with the conditions for the SPR are fulfilled, the method includes detecting, by the UE, a second event. The second event includes at least one of a successful delivery of a UEInformationResponse message including SPR confirmed by a lower layer, a timer expiry at the UE after the SPR is stored, and storing a new SPR. Further, the method includes clearing, by the UE, the stored SPR upon detecting the second event.

In an embodiment, upon initiating the RRC Resume procedure, the UE releases the SPR configuration for logging and reporting the successful PSCell addition or the PSCell change information in a successPAC-Config (e.g., successPSCell-Config or the like) if the SPR configuration is stored. The SPR configuration includes at least one of a successPAC-Config configured by at least one of: a PCell, a source PSCell and a target PSCell.

In an embodiment, upon initiating the RRC Reestablishment procedure, the UE releases the SPR configuration for logging and reporting the SPR. The SPR configuration includes a successPAC-Config configured by at least one of: the PCell, the source PSCell and the target PSCell.

In an embodiment, upon initiating the SCG failure information procedure, the UE releases the SPR configuration for logging and reporting the SPR. The SPR configuration includes at least one of a successPAC-Config configured by at least one of the PCell, the source PSCell and the target PSCell.

In an embodiment, upon detecting the change of the PCell, the UE releases the SPR configuration by performing an operations such as the UE releases the SPR configuration for logging and reporting of the SPR included in successPAC-Config configured for logging and reporting information for the successful PSCell change if the successful PSCell change is configured by the PCell.

In another embodiment, upon detecting the change of the PCell, the UE releases the SPR configuration by performing an operations such as the UE releases all successPAC-Config configured by at least one of a PCell, a source PSCell and a target PSCell.

In an embodiment, the change of the PCell is due to at least one of a Lower Layer Triggered Mobility (LTM) and a RRC Reconfigurationwithsync.

In an embodiment, upon determining the SCG Release, the UE releases the SPR configuration for logging and reporting of the SPR. The released configuration includes at least one of a success PAC-Config configured by at least one of: a PCell, a source PSCell and a target PSCell.

In an embodiment, upon determining the successful PSCell change, the UE clears the SPR configuration for the logging and reporting of the SPR included in a successPACConfig configured by at least one of source PSCell, a PCell and a part of successPACConfig including a T304 threshold configured by the target PSCell for the logging and reporting of the SPR and keeping the T310 and T312 thresholds configured by the target PSCell.

In an embodiment, when the UE stores a Conditional PS Cell Change (CPC) configuration after the PSCell change to the target cell through selective activation of cell groups, the UE skips releasing the SPR configuration or a part of SPR configuration in a successPAC-Config, for a target PSCell threshold configured by a target PSCell.

In another embodiment, when the UE stores the CPC configuration for a candidate cell after a successful PSCell change, the UE skips releasing a successPAC-Config or a part of successPAC-Config configured by a candidate cell.

Accordingly, the embodiments herein discloses a UE including a SPR configuration controller coupled with a processor and a memory. The SPR configuration controller is configured to receive a SPR configuration from a network entity in the wireless network. Further, the SPR configuration controller is configured to detect a first event. The first event includes one of: initiation of a RRC reestablishment procedure, initiation of a RRC resume procedure, a SCG failure, a change of a PCell due to a handover procedure, a LTM at the PCell, a SCG release, a successful PSCell change, a successful PSCell addition, a successful PSCell change with conditions for the SPR are fulfilled, and a successful PSCell addition with conditions for the SPR are fulfilled. In an embodiment, the SPR configuration controller is configured to log the SPR upon detecting one of the successful PSCell change with the conditions for the SPR are fulfilled, and the successful PSCell addition with the conditions for the SPR are fulfilled based on the detected first event. In another embodiment, the SPR configuration controller is configured to release the SPR configuration upon detecting one of: the RRC reestablishment procedure, the RRC resume procedure, the SCG failure, the change of the PCell due to the handover procedure, the LTM at the PCell, the SCG release, a successful PSCell change, and the Successful PSCell addition based on the detected first event.

Embodiments herein disclose methods for handling successful primary and Successful PSCell Report (SPR) in wireless network by UE. The method includes receiving a SPR configuration from network entity. Further, the method includes detecting an event (e.g., initiation of a RRC reestablishment procedure, initiation of a RRC resume procedure, a SCG failure, a change of a PCell due to a handover procedure, a LTM at the PCell, a SCG release, a successful PSCell change, a successful PSCell addition, a successful PSCell change with conditions for the SPR are fulfilled, and a successful PSCell addition with conditions for the SPR are fulfilled or the like). In an embodiment, the method includes logging the SPR upon detecting one of the successful PSCell change with the conditions for the SPR are fulfilled, and the successful PSCell addition with conditions for the SPR are fulfilled based on the detected first event.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The present disclosure provides an effective and efficient method for handling successful primary and Successful PSCell Report (SPR) in wireless network. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for handling a successful primary and Successful PSCell Report (SPR), according to embodiments as disclosed herein;

FIG. 2 and FIG. 3 are flow chart illustrating a method for handling the successful primary and Successful PSCell Report (SPR) in the wireless network, according to embodiments as disclosed herein;

FIG. 4 is an example flow diagram illustrating a method for releasing SPR configuration during various events in the UE, according to embodiments as disclosed herein;

FIG. 5 is an example flow diagram illustrating a method for releasing SPR configuration on PSCell change or PSCell addition, according to embodiments as disclosed herein;

FIG. 6 is an example flow diagram illustrating a method for clearing SPR, according to embodiments as disclosed herein;

FIG. 7 is an example sequence diagram illustrating SPR logging, according to embodiments as disclosed herein; and

FIG. 8 is an example sequence diagram illustrating handling SPR overwrite issue, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve methods for handling a successful primary and Successful PSCell Report (SPR) in a wireless network. The SPR is used to provide the successful PSCell change or addition report if triggered based on the successful PSCell change or addition report configuration (SPR configuration). The method includes receiving, by a UE, a SPR configuration from a network entity in the wireless network. Further, the method includes detecting, by the UE, a first event. The first event includes one of: initiation of a RRC reestablishment procedure, initiation of a RRC resume procedure, a SCG failure, a change of a PCell due to a handover procedure, a LTM at the PCell, a SCG release, a successful PSCell change, a successful PSCell addition, a successful PSCell change with conditions for the SPR are fulfilled, and a successful PSCell addition with conditions for the SPR are fulfilled. In an embodiment, the method includes logging the SPR upon detecting one of the successful PSCell change with the conditions for the SPR are fulfilled, and the successful PSCell addition with the conditions for the SPR are fulfilled based on the detected first event. In another embodiment, the method includes releasing the SPR configuration upon detecting one of: the RRC reestablishment procedure, the RRC resume procedure, the SCG failure, the change of the PCell due to the handover procedure, the LLTM at the PCell, the SCG release a successful PSCell change, and the Successful PSCell addition based on the detected first event.

In a dual connectivity scenario, the method can be used for configuring, reporting and releasing the configuration of UE for reporting information related to successful PS cell addition and change. The method can be used for self-optimization of PS cell change and PS cell addition procedures in the dual connectivity scenarios. The method can be used to store and report the PS cell change and PS cell addition procedures in a successful PS Cell Report (SPR).

In an embodiment, the UE stores the SPR at most 48 hours after the last successful PSCell addition/PSCell change report is stored at the UE if the SPR is not fetched by the network. At least the following options are needed for releasing SPR report such as new SPR is initiated and upon retrieval of SPR.

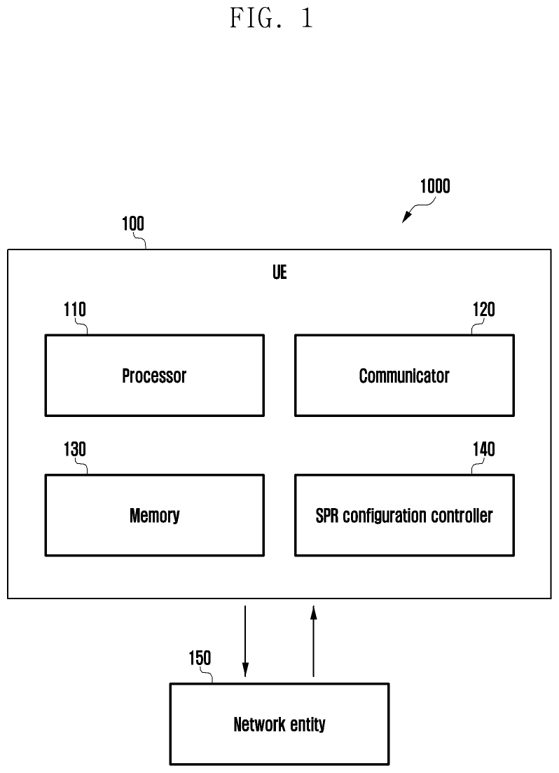

Referring now to the drawings, and more particularly to FIG. 1 through FIG. 8, where similar reference characters denote corresponding features consistently throughout the figures, there are shown at least one embodiment.

FIG. 1 illustrates a wireless network (1000) for handling a successful primary and Successful PSCell Report (SPR), according to embodiments as disclosed herein. In an embodiment, the wireless network (1000) includes a UE (100) and a network entity (150). The wireless network (1000) can be, for example, but not limited to a fourth generation (4G) network, a fifth generation (5G) network, an Open Radio Access Network (ORAN) or the like. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network entity (150) can be, for example, but not limited to an gNB, an eNB, a new radio (NR) trans-receiver, a 5G base station or the like.

In an embodiment, the UE (100) includes a processor (110), a communicator (120), a memory (130) and a SPR configuration controller (140). The processor (110) is coupled with the communicator (120), the memory (130) and the SPR configuration controller (140).

The SPR configuration controller (140) receives a SPR configuration from the network entity (150). Further, the SPR configuration controller (140) detects a first event. The first event can be, for example, but not limited to initiation of a RRC reestablishment procedure, initiation of a RRC resume procedure, a SCG failure, a change of a PCell due to a handover procedure, a LTM at the PCell, a LTM at the PSCell, a SCG release, a successful PSCell change, a successful PSCell addition, a successful PSCell change with conditions for the SPR are fulfilled, and a successful PSCell addition with conditions for the SPR are fulfilled. Based on the detected first event, in an embodiment, the SPR configuration controller (140) logs the SPR upon detecting one of the successful PSCell change with the conditions for the SPR are fulfilled, and the successful PSCell addition with the conditions for the SPR are fulfilled.

Based on the detected first event, in another embodiment, the SPR configuration controller (140) releases the SPR configuration upon detecting one of: the RRC reestablishment procedure, the RRC resume procedure, the SCG failure, the change of the PCell due to the handover procedure, the LLTM at the PCell, the SCG release a successful PSCell change, and the Successful PSCell addition.

After storing the SPR upon determining one of: the successful PSCell change with the conditions for the SPR are fulfilled and the successful PSCell addition with the conditions for the SPR are fulfilled, the SPR configuration controller (140) detects a second event. The second event can be, for example, but not limited to a successful delivery of a UEInformationResponse message including SPR confirmed by a lower layer, a timer expiry at the UE (100) after the SPR is stored, and storing a new SPR. Further, the SPR configuration controller (140) clears the stored SPR upon detecting the second event.

In an embodiment, upon initiating the RRC Resume procedure, the SPR configuration controller (140) releases the SPR configuration for logging and reporting the successful PSCell addition or the PSCell change information in a successPAC-Config (e.g., successPSCell-Config or the like) if the SPR configuration is stored. The SPR configuration includes all successPAC-Config configured by PCell, source PSCell or target PSCells.

In an embodiment, upon initiating the RRC Reestablishment procedure, the SPR configuration controller (140) releases the SPR configuration for logging and reporting the SPR. The SPR configuration includes a successPAC-Config configured by the PCell, the source PSCell and the target PSCell.

In an embodiment, initiating the SCG failure information procedure, the SPR configuration controller (140) releases the SPR configuration for logging and reporting the SPR. The SPR configuration includes a successPAC-Config configured by the PCell, the source PSCell and the target PSCell.

In an embodiment, upon detecting the change of the PCell, the SPR configuration controller (140) releases the SPR configuration by performing an operation such as the SPR configuration controller (140) releases the SPR configuration for logging and reporting of the SPR included in successPAC-Config configured for logging and reporting information for the successful PSCell change if the successful PSCell change is configured by the PCell. SPR configuration controller (140) may keep the SPR configuration for logging and reporting of the SPR included in successPAC-Config configured by the source or target PSCell. In another embodiment, upon detecting the change of the PCell, the SPR configuration controller (140) releases the SPR configuration by performing an operation such as the SPR configuration controller (140) releases all successPAC-Config configured by the PCell, the source PSCell and the target PSCells. The change of the PCell is due to at least one of the LTM and a RRC Reconfigurationwithsync.

In an embodiment, upon determining the SCG Release, the SPR configuration controller (140) releases the SPR configuration for logging and reporting of the SPR. The released configuration includes a success PAC-Config configured by the PCell, the source PSCell and the target PSCell.

In an embodiment, upon determining the successful PSCell change, the the SPR configuration controller (140) clears the SPR configuration for the logging and reporting of the SPR included in a successPAC-Configconfigured by at least one of source PSCell, a PCell and a part of successPAC-Config including a threshold configured by the target PSCell for the logging and reporting of the SPR. There can be three thresholds configured by the target PSCell: t310,t312,t304. The part of successPACConfig that will be released is t304 threshold.

In an embodiment, when the UE (100) stores a Conditional PSCell Change (CPC) configuration after the PSCell change to the target cell through selective activation of cell groups, the SPR configuration controller (140) skips releasing the SPR configuration or the part of SPR configuration in the successPAC-Config, for a target PSCell threshold configured by a target PSCell. That is, the SPR configuration controller (140) keeps the SPR configuration including the T304 threshold configured by the target cell. In another embodiment, when the UE (100) stores the CPC configuration for a candidate cell after a successful PSCell change, the the SPR configuration controller (140) skips releasing a successPAC-Config or a part of successPAC-Config configured by a candidate cell. That is, the SPR configuration controller (140) keeps the SPR configuration including the T310,T312 and T304 thresholds configured by the candidate cells.

In another embodiment, the SPR configuration controller (140) stores a source PSCell configuration after a PSCell change. Upon storing the source PSCell configuration after the PSCell change, the SPR configuration controller (140) performs a selective activation of a cell group to a source PSCell. Further, the SPR configuration controller (140) skips to release a configuration or part of the configuration for SPR included in success PAC-Configconfigured by the source PSCell. That is, the SPR configuration controller (140) keeps the SPR configuration including the T310,T312 and T304 thresholds configured by the source cell.

The SPR configuration controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 1 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

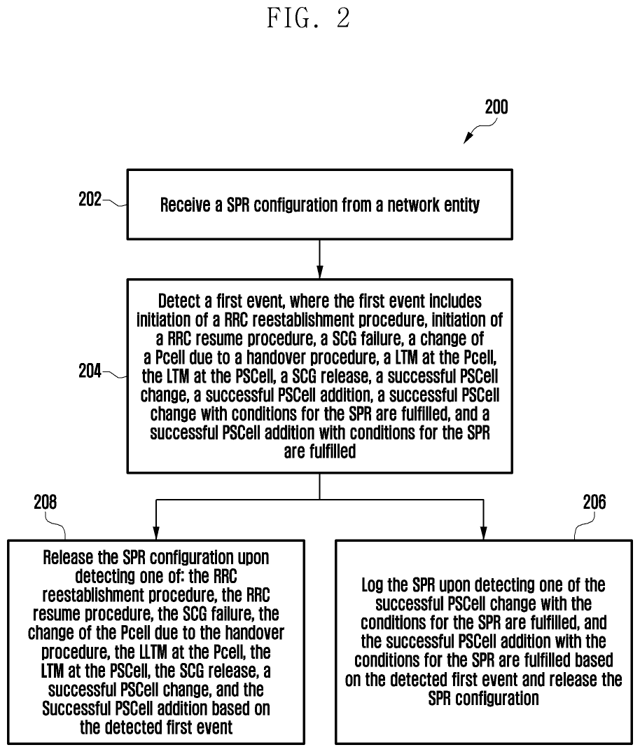

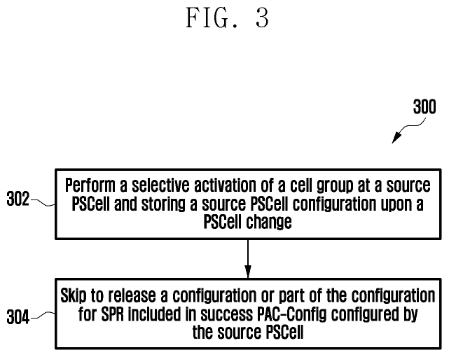

FIG. 2 and FIG. 3 are flow charts (200 and 300) illustrating a method for handling the successful primary and Successful PSCell Report (SPR) in the wireless network (1000), according to embodiments as disclosed herein.

As shown in FIG. 2, the operations (202-208) are handled by the SPR configuration controller (140). At 202, the method includes receiving the SPR configuration from the network entity (150). At 204, the method includes detecting the first event. The first event includes one of: initiation of a RRC reestablishment procedure, initiation of the RRC resume procedure, the SCG failure, the change of the PCell due to the handover procedure, the LTM at the PCell, the LTM at the PSCell, the SCG release, the successful PSCell change, the successful PSCell addition, the successful PSCell change with conditions for the SPR are fulfilled, and the successful PSCell addition with conditions for the SPR are fulfilled.

In an embodiment, at 206, the method includes logging the SPR upon detecting one of the successful PSCell change with the conditions for the SPR are fulfilled, and the successful PSCell addition with the conditions for the SPR are fulfilled based on the detected first event and releasing the SPR configuration. In another embodiment, at 208, the method includes releasing the SPR configuration upon detecting one of: the RRC reestablishment procedure, the RRC resume procedure, the SCG failure, the change of the PCell due to the handover procedure, the LTM at the PCell, the LTM at the PSCell, the SCG release, a successful PSCell change, and the Successful PSCell addition based on the detected first event.

As shown in FIG. 3, the operations (302-304) are handled by the SPR configuration controller (140). At 302, the method includes performing the selective activation of the cell group at the source PSCell and storing the source PSCell configuration upon the PSCell change. At 304, the method includes skipping to release the configuration or part of the configuration for SPR included in the success PAC-Config configured by the source PSCell.

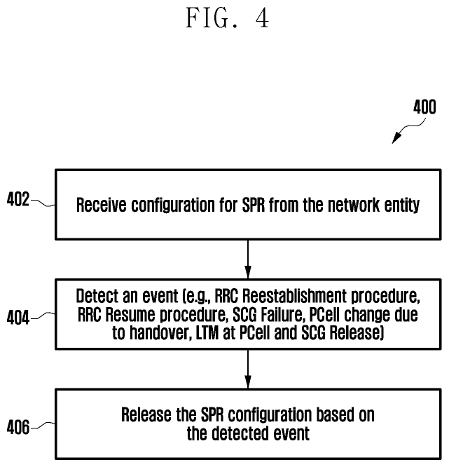

FIG. 4 is an example flow diagram (400) illustrating a method for releasing SPR configuration during various events in the UE (100), according to embodiments as disclosed herein.

As shown in FIG. 4, the operations (402-406) are handled by the SPR configuration controller (140). At 402, the method includes receiving the configuration for the SPR from the network entity (150). At 404, the method includes detecting the event (such as RRC Reestablishment procedure, RRC Resume procedure, SCG Failure, PCell change due to handover, LTM at PCell and SCG Release or the like). At 406, the method includes releasing the SPR configuration based on the detected event.

In an embodiment, the network entity (e.g., gNB in the NR) (150) configures the UE (100) to log and report the SPR through the RRC messages and IEs like IE otherConfig in RRC Reconfiguration. The configuration for the logging and reporting of the SPR may be called successPAC-Config in the proposed method. The network entity (150) configures the UE (100) for reporting information related to successful PSCell change or successful PSCell Addition in the SPR through the successPAC-Config. The SPR configuration, and the successPAC-Config can include one or more of different triggering conditions disclosed below:
T310 trigger: The T310 trigger (i.e., threshold) (for e.g., thresholdPercentageT310) will be configured by the source PSCell. Alternatively, the T310 trigger may be configured by the PCell. The Source PSCell or PCell will configure T310 trigger in the configuration for the SPR for reporting successful PSCell Change information and not in the configuration for reporting successful PSCell Addition information.
T312 trigger: The T312 trigger (i.e., threshold) (for e.g., thresholdPercentageT312) will be configured by the source PSCell. Alternatively, the T312 trigger may be configured by the PCell. The source PSCell or the PCell will configure T312 trigger in the configuration for reporting successful PSCell change information and not in the configuration for reporting successful PSCell addition information.
T304 trigger: the T304 trigger (i.e., threshold) (for e.g., thresholdPercentageT304) will be configured by the target PSCell. Alternatively, the T304 trigger may be configured by the PCell. For example, if the threshold is 40% for T304, then the UE (100) logs successful PSCell Addition or PSCell Change report, if the value of elapsed timer for T304 in target cell is at least 40% of the T304 configured for the PSCell Addition or PSCell Change.

A sample configuration is given below:

```
  SuccessPAC-Config-r17 ::= SEQUENCE {
  thresholdPercentageT304-r17 ENUMERATED {p40, p60, p80, spare5, spare4,
spare3, spare2, spare1} OPTIONAL, --Need R
  thresholdPercentageT310-r17 ENUMERATED {p40, p60, p80, spare5, spare4,
spare3, spare2, spare1} OPTIONAL, --Need R
  thresholdPercentageT312-r17 ENUMERATED {p20, p40, p60, p80, spare4, spare3,
spare2, spare1} OPTIONAL, --Need R
  ...
  }
```

The target PSCell/PCell configures the T304 trigger in the configuration for reporting successful PSCell Change information and in the configuration for reporting successful PSCell Addition information, if the UE (100) is configured to perform random access after PSCell addition. If the SCG is deactivated upon the PSCell Change or PSCell addition, the target PSCell doesn't configure T304 trigger. In an embodiment, if the target PSCell configures the T304 trigger and also configures the target SCG as deactivated, the UE (100) ignores the configuration of T304 threshold.

In an embodiment, the successPAC-Config may have different fields for thresholds in the configuration, to distinguish between the thresholds for PSCell Change or PSCell Addition. For e.g., the field PSCellAddition-thresholdPercentageT304-r17 is for configuration of reporting of successful PSCellAddition information while the field PSCellChange-thresholdPercentageT304-r17 is for configuration of reporting of successful PSCellChange information.

```
  SuccessPAC-Config-r17 ::= SEQUENCE {
  PSCellAddition-thresholdPercentageT304-r17 ENUMERATED {p40, p60, p80,
spare5, spare4, spare3, spare2, spare1} OPTIONAL, --Need R
  PSCellChange-thresholdPercentageT304-r17 ENUMERATED {p40, p60, p80,
spare5, spare4, spare3, spare2, spare1} OPTIONAL, --Need R
  PSCellChange-thresholdPercentageT310-r17 ENUMERATED {p40, p60, p80,
spare5, spare4, spare3, spare2, spare1} OPTIONAL, --Need R
  PSCellChange-thresholdPercentageT312-r17 ENUMERATED {p20, p40, p60, p80,
spare4, spare3, spare2, spare1} OPTIONAL, --Need R
  ...
  }
```

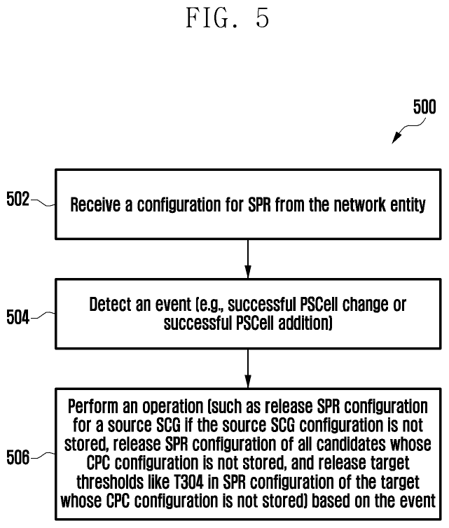

FIG. 5 is an example flow diagram (500) illustrating a method for releasing SPR configuration on the PSCell change or the PSCell addition, according to embodiments as disclosed herein.

As shown in FIG. 5, the operations (502-506) are handled by the SPR configuration controller (140). At 502, the method includes receiving the configuration for SPR from the network entity (150). At 504, the method includes detecting the event (such as successful PSCell change or successful PSCell addition or the like). At 506, the method includes performing an operation (such as release SPR configuration for the source SCG if the source SCG configuration is not stored, release SPR configuration of all candidates whose CPC configuration is not stored, and release target thresholds like T304 in SPR configuration of the target whose CPC configuration is not stored) based on the event.

Upon initiating the RRC resume procedure, the UE (100) releases the configuration for logging and reporting the successful PSCell addition or the PSCell change information, successPAC-Config if this configuration is stored. The released configuration includes all successPAC-Config configured by the PCell, the source PSCell or the target PSCells. Alternately, the released configuration includes at least one success PAC-Config configured by the PCell, the source PSCell and the target PSCells. Example changes based on 3GPP TS 38.331 section 5.3.13.2 is given below.

### Initiation

Upon initiation of the procedure, the UE (100) shall:
<some text>
1> release successPAC-Config from the UE Inactive AS context, if stored;
<some text>

In an embodiment, the UE (100) releases successPAC-Config during the RRC Reestablishment procedure (RRC Reestablishment procedure includes the various steps as detailed in 3GPP TS 38.331 section 5.3.7, i.e. from sections 5.3.7.1 to 5.3.7.8). In an embodiment, upon initiating the RRC Reestablishment procedure, the UE (100) releases the configuration for logging and reporting SPR, successPAC-Config, if configured. The released configuration includes all successPAC-Config configured by the PCell, the source PSCell and the target PSCells. Alternately, the released configuration includes at least one successPAC-Config configured by the PCell, the source PSCell or the target PSCells. Example changes based on 3GPP TS 38.331 section 5.3.7.2 is given below.
Initiation
Upon initiation of the procedure, the UE (100) shall:
<some text>
1> release successPAC-Config, if configured.
<some text>

In an embodiment, the UE (100) releases successPAC-Config during SCGFailureInformation procedure (SCGFailureInformation procedure includes the various steps as detailed in the 3GPP TS 38.331 section 5.7.3, i.e. from sections 5.7.3.1 to 5.3.7.5). Upon initiating SCGFailureInformation, the UE (100) releases the configuration for logging and reporting SPR, successPAC-Config, if configured. The released configuration includes all successPAC-Config configured by the PCell, the source PSCell or the target PSCells. Alternately, the released configuration includes at least one of successPAC-Config configured by the PCell, the source PSCell or the target PSCells. Example changes based on the 3GPP TS 38.331 section 5.7.3.2 is given below.

Upon initiating the procedure, the UE (100) shall:
<some text>
1> release successPAC-Config from the UE Inactive AS context, if stored;
<some text>

In an embodiment, the UE (100) releases successPAC-Config during the RRC Resume procedure (RRC Resume procedure includes the various steps as detailed in the 3GPP TS 38.331 section 5.7.3, i.e. from sections 5.7.3.1 to 5.3.7.5). In an embodiment, upon receiving RRCRelease with suspendconfig, the UE (100) stores the set of configurations of the UE (100), but excludes the configuration for logging and reporting SPR, successPAC-Config), even if configured, from the storing.

On a PCell change, the UE (100) releases the configuration for the logging and reporting of SPR, included in successPAC-Config configured for logging and reporting information for successful PSCell Addition. In another embodiment, on the PCell change, the UE (100) releases the configuration for the logging and reporting of SPR, included in successPAC-Config configured for logging and reporting information for the successful PSCell change if it is configured by the PCell. In another embodiment, the UE (100) releases all the successPAC-Config configured by the PCell, the source PSCell or the target PSCells during PCell Change. Alternately, the released configuration includes at least one of success PAC-Config configured by the PCell, the source PSCell or the target PSCells. In an embodiment, the PCell change is due to Lower Layer Triggered Mobility (i.e., R18 LTM) and in another embodiment, the PCell change is due to L3 mobility (RRC Reconfigurationwithsync). The PCell change may due to other events as well.

On Secondary cellgroupconfig release (SCGRelease), the UE (100) releases the configuration for logging and reporting of SPR. The released configuration includes all success PAC-Config configured by the PCell, the source PSCell or the target PSCells. Alternately, the released configuration includes at least one of success PAC-Config configured by the PCell, the source PSCell or the target PSCells. Example changes based on the 3GPP TS 38.331 section 5.3.5.4 is given below.

### Secondary Cell Group Release

The UE (100) shall:
1> as a result of SCG release triggered by an E-UTRA (i.e. (NG)EN-DC case) or NR (i.e. NR-DC case):
<some text>
2> if SCG release was triggered by NR (i.e. NR-DC case):
2> remove all the entries within the MCG VarConditionalReconfig for which the RRCReconfiguration within condRRCReconfig does not include the masterCellGroup with reconfigurationWithSync, if any;
3> release successPAC-Config, if configured;
2> else (i.e. EN-DC case):
3> perform VarConditionalReconfiguration CPC removal as specified in TS 36.331 clause 5.3.5.9.7;

On successful PSCell change, the UE (100) clears the configuration for the logging and reporting of the SPR, included in successPAC-Config configured by the source PSCell or the PCell and a part of successPAC-Config including any threshold configured by the target PSCell (for e.g. T304 threshold) for the logging and reporting of the SPR. In an embodiment, if the UE (100) stores the CPC configuration after the PSCell change or CPA configuration after the PSCell addition for the target cell (i.e., UE (100) performs a R18 selective activation of the cell groups including the target cell), the UE (100) skips releasing the SPR configuration or part of SPR configuration in successPAC-Config, for the target PSCell thresholds configured by the target PSCell. The R18 selective activation is the CPC Or CPA where the UE (100) stores the CPC configuration after the PSCell change or PSCell addition for the target cell. In an embodiment, if the UE (100) stores the CPC configuration for any candidate cell after the successful PSCell change, the UE (100) skips releasing successPAC-Config or the part of successPAC-Config configured by that candidate cell.

In an embodiment, if the UE (100) doesn't store the CPC configuration after PSCell change or CPA configuration after the PSCell addition for the candidate cell (i.e. the UE (100) doesn't perform R18 selective activation of cell groups including this candidate cell), the UE (100) releases the SPR configuration or part of the SPR configuration, configured by the candidate cell unless it is the successfully changed target PSCell. For the successfully changed target PSCell, if the UE (100) doesn't store the CPC configuration after PSCell change for the target cell or CPA configuration after the PSCell addition, (i.e., the UE (100) doesn't perform R18 selective activation of cell groups including the target cell), the UE (100) stores the T310, T312 and any other threshold applicable for the operation of this target cell as a source cell for a subsequent PSCellChange and releases all other thresholds including T304 threshold.

In an embodiment, if the UE (100) stores the source PSCell configuration after PSCell change, so that selective activation of cell groups could be performed to the source PSCell (i.e., the UE (100) can perform PSCellChange to the source cell using the stored configuration), the UE (100) skips releasing the configuration or part of the configuration for SPR, included in success PAC-Configconfigured by the source PSCell.

On successful PSCell addition, the UE (100) clears the configuration for the successful PSCell Addition reporting (e.g., configured by the PCell) and any threshold (i.e., configuration) configured by the target PSCell for the successful PSCell Addition reporting.

The UE may indicate t304-cause, t310-cause, t312-cause based on the threshold satisfied during successful PSCell change in Successful PSCell report. Successful PSCell Report may be referred as SuccessPAC-Report (or SuccessPSCell-Report-r18 or any equivalent/similar name in different technologies). The UE (100) may indicate t304-cause (and will not indicate t310-cause, t312-cause), based on the threshold satisfied during Successful PSCell Addition in Successful PSCell report.

The UE may indicate that RA was not performed in the successful PSCell Change information or successful PSCell Addition information (e.g., SPR) when the SCG status is deactivated after the PSCell change and the PSCell Addition and RA is not needed.

In an embodiment, the indication is reported by not including the RA information in the SPR. In an embodiment, the indication is reported by not including the RA information in the SPR when the trigger for storing and reporting SPR is T304 trigger. In an embodiment, the indication is reported by including the specific flag in RA report.

In an embodiment, the RA information is not included if the successful PSCell Change information (e.g., SPR) is triggered due to a configuration from source PSCell such as T310 trigger or T312 trigger.

In an embodiment, SPR contains information:

TABLE 1
c-RNTI
This field indicates the C-RNTI assigned by the target PSCell
of the PSCell Addition or PSCell Change for which the successful PAC
report (successful PACreport stores SPR) was generated.
measResultListNR
This field refers to the last measurement results taken in the neighboring
NR Cells when a successful PSCell Addition or PSCell Change is
executed.
Spr-Cause
This field is used to indicate the cause of the successful PSCell report.
sourceCellMeas
This field refers to the last measurement results taken in the source PSCell
of a PS-CellChange in which the successful PSCell Change trigger SPR
sourcePSCellID
This field is used to indicate the source PSCell of a PSCell change in
which the successful PSCell change triggers the SuccessPAC-Report.
targetPSCellID
This field is used to indicate the target PSCell of a PSCellChange in which
the successful PSCell change or the PSCell where successful PSCell
Addition triggers the SuccessPAC-Report
targetCellMeas
This field refers to the last measurement results taken in the target
PSCell of a PSCell change or PSCell Addition in which the successful
PSCell change or successful
PSCell Addition triggers the SuccessPAC-Report
timeSinceCPAC-Reconfig
This field is used to indicate the time elapsed between the initiation
of the last conditional PSCell addition or PSCell change execution
towards the target cell and the reception of the latest conditional
reconfiguration for this target cell. Actual value = field value * 100 ms.
The maximum value 1023 means 102.3 s or longer.

A sample definition of SuccessPAC-Report is given below:

SuccessPAC-Report-r17 ::= SEQUENCE {
sourcePSCellInfo-r17 SEQUENCE {
sourcePSCellId-r17 CGI-Info-Logging-r16,
sourceCellMeas-r17 MeasResultSuccessPACNR-r17 OPTIONAL,
},
targetCellInfo-r17 SEQUENCE {
targetPSCellId-r17 CGI-Info-Logging-r16,
targetCellMeas-r17 MeasResultSuccessPACNR-r17 OPTIONAL
},
measResultNeighCells-r17 SEQUENCE {
measResultListNR-r17 MeasResultList2NR-r16 OPTIONAL,
} OPTIONAL,
locationInfo-r17 LocationInfo-r16 OPTIONAL,
timeSinceCPAC-Reconfig-r17 TimeSinceCPAC-Reconfig-r17 OPTIONAL,
shr-Cause-r17 SHR-Cause-r17 OPTIONAL,
ra-InformationCommon-r17 RA-InformationCommon-r16 OPTIONAL,
c-RNTI-r17 RNTI-Value OPTIONAL,
...
}

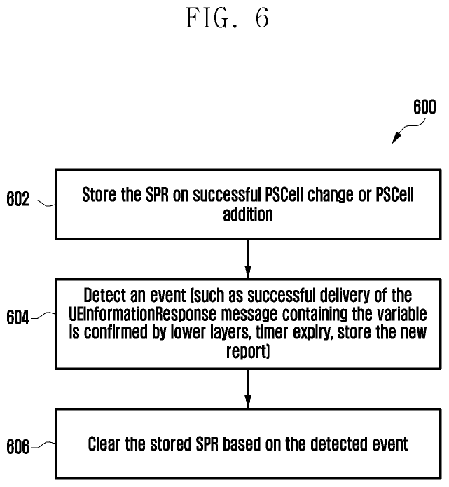

FIG. 6 is an example flow diagram (600) illustrating a method for clearing SPR, according to embodiments as disclosed herein.

As shown in FIG. 6, the operations (602-606) are handled by the SPR configuration controller (140). At 602, the method includes storing the SPR on the successful PSCell change or the PSCell addition. At 604, the method includes detecting the event (such as successful delivery of the UEInformationResponse message containing the variable is confirmed by the lower layers, the timer expiry, or storing the new report). At 606, the method includes clearing the stored SPR based on the detected event.

The UE (100) discards the successful PSCell Addition or change information, i.e., release the UE variable which store successful PSCell Addition or change information (for e.g., VarSuccessPAC-Report or any other variable name), upon expiry of the timer (for e.g. 48h (after the last successful PSCell Addition or Change Information is added to the said variable (for e.g. VarSuccessPAC-Report). The UE (100) discards the above variable (for e.g., VarSuccessPAC-Report) upon successful delivery of the UEInformationResponse message containing the variable is confirmed by lower layers. Some of the sample changes in TS 38.331 for the above embodiments is given below:

Actions for the successful PSCell report determination.

The UE (100) shall for the PSCell:
1> if the ratio between the value of the elapsed time of the timer T304 and the configured value of the timer T304, included in the last applied RRCReconfiguration message including the reconfigurationWithSync, is greater than thresholdPercentageT304 if included in the successHO-Config received before executing the last reconfiguration with sync; or
1> if the ratio between the value of the elapsed time of the timer T310 and the configured value of the timer T310, configured by the source PSCell or configured by the PCell while the UE (100) was connected to the source PCell before executing the last reconfiguration with sync, is greater than thresholdPercentageT310 included in the successHO-Config if configured by the source PSCell or the PCell before executing the last reconfiguration with sync; or
1> if the T312 associated to the measurement identity of the target cell was running at the time of initiating the execution of the reconfiguration with sync procedure and if the ratio between the value of the elapsed time of the timer T312 and the configured value of the timer T312, configured by the source PSCell or configured by the PCell while the UE was connected to the source PCell before executing the last reconfiguration with sync, is greater than thresholdPercentageT312 included in the successHO-Config if configured by the source PSCell or sourcePCell before executing the last reconfiguration with sync; or
2> store the successful PSCell information in VarSuccessPAC-Report and determine the content in VarSuccessPAC-Report as follows:
3> clear the information included in VarSuccessPAC-Report, if any;
3> if registered on PLMN
4> set the plmn-IdentityList to include the list of EPLMNs stored by the UE (i.e., includes the RPLMN);
3> else if registered on PNI-NPN
4> store the PLMN ID and CAG-ID to include the list of PNI-NPN Ids stored by the UE (i.e., includes the RPLMN);
3> else if registered on SNPN
4> store the SNPN ID to include the list of SNPN Ids stored by the UE (i.e., includes the RPLMN);
<some text>
1> release successPAC-Config configured by the source PSCell or PCell if the source PSCell configuration is not stored and thresholdPercentageT304 if configured by the target PCell,

The UE (100) may discard the successful PSCell addition or change information, i.e., release the UE variable VarSuccessPAC-Report, 48 hours after the last successful handover information is added to the VarSuccessPAC-Report.

The actions for the successful PSCell report determination, the UE (100) shall for the PSCell: if the ratio between the value of the elapsed time of the timer T304 and the configured value of the timer T304, included in the last applied RRCReconfiguration message including the reconfigurationWithSync, is greater than thresholdPercentageT304 if included in the successHO-Config received before executing the last reconfiguration with sync; or if the ratio between the value of the elapsed time of the timer T310 and the configured value of the timer T310, configured by the source PSCell or configured by the PCell while the UE (100) was connected to the source PCell before executing the last reconfiguration with sync, is greater than thresholdPercentageT310 included in the success HO-Config if configured by the source PSCell or the PCell before executing the last reconfiguration with sync; or if the T312 associated to the measurement identity of the target cell was running at the time of initiating the execution of the reconfiguration with sync procedure and if the ratio between the value of the elapsed time of the timer T312 and the configured value of the timer T312, configured by the source PSCell or configured by the PCell while the UE (100) was connected to the source PCell before executing the last reconfiguration with sync, is greater than thresholdPercentageT312 included in the successHO-Config if configured by the source PSCell or sourcePCell before executing the last reconfiguration with sync or store the successful PSCell information in VarSuccessPAC-Report and determine the content in VarSuccessPAC-Report as follows: clear the information included in VarSuccessPAC-Report, if any; if registered on PLMN set the plmn-IdentityList to include the list of EPLMNs stored by the UE (100) (i.e., includes the RPLMN); else if registered on PNI-NPN store the PLMN ID and CAG-ID to include the list of PNI-NPN Ids stored by the UE (i.e., includes the RPLMN); else if registered on SNPN, store the SNPN ID to include the list of SNPN Ids stored by the UE (100) (i.e., includes the RPLMN);Release successPAC-Config configured by the source PSCell or PCell if the source PSCell configuration is not stored and thresholdPercentageT304 if configured by the target PCell.

The UE (100) may discard the successful PSCell addition or change information i.e., release the UE variable VarSuccessPAC-Report, 48 hours after the last successful handover information is added to the VarSuccessPAC-Report.

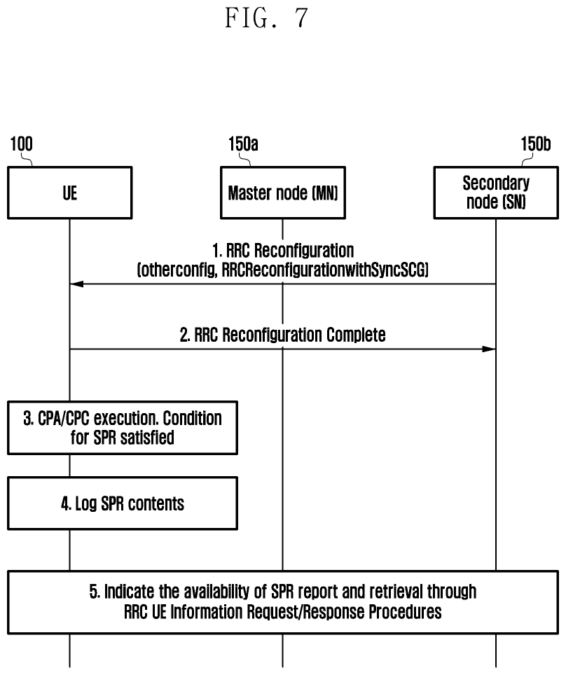

FIG. 7 is an example illustrating SPR logging, according to embodiments as disclosed herein. In an embodiment, while storing the Successful PSCell Report, the UE (100) camped on the PNI-NPN stores the NPN identifier of the PNI-NPN (e.g., PLMN ID+CAG-ID) where the UE (100) was registered when the report is stored. In the NR, the UE (100) may store the information in a variable called npn-IdentityInfoList. In an embodiment, when the UE (100) receives the request to report SPR in the UE Information Request, the UE (100) includes the corresponding report in the RRC message like UE Information Response if the registered PNI-NPN (e.g., PLMN ID+CAG-ID) is included in the variable npn-IdentityInfoList stored in report.

In an embodiment, if the UE (100) has SPR available and if the registered PNI-NPN (e.g., PLMN ID+CAG-ID) is included in npn-IdentityInfoList stored in report, the UE (100) includes an indication that above reports is available in RRC Setup Complete message or RRC Resume Complete message or RRC Reestablishment Complete message.

As shown in FIG. 7, at 1, the UE (100) receives the RRC Reconfiguration (otherconfig, RRCReconfigurationwithSyncSCG) from the secondary node (SN) (150b). At 2, the UE (100) sends the RRC reconfiguration complete to the secondary node (SN) (150b). At 3, the UE (100) performs the CPA/CPC execution and determines that the condition for the SPR is satisfied. At 4, the UE (100) logs the SPR contents. At 5, the UE (100) indicates the availability of the SPR report and retrieval through the RRC UE information request/response procedures.

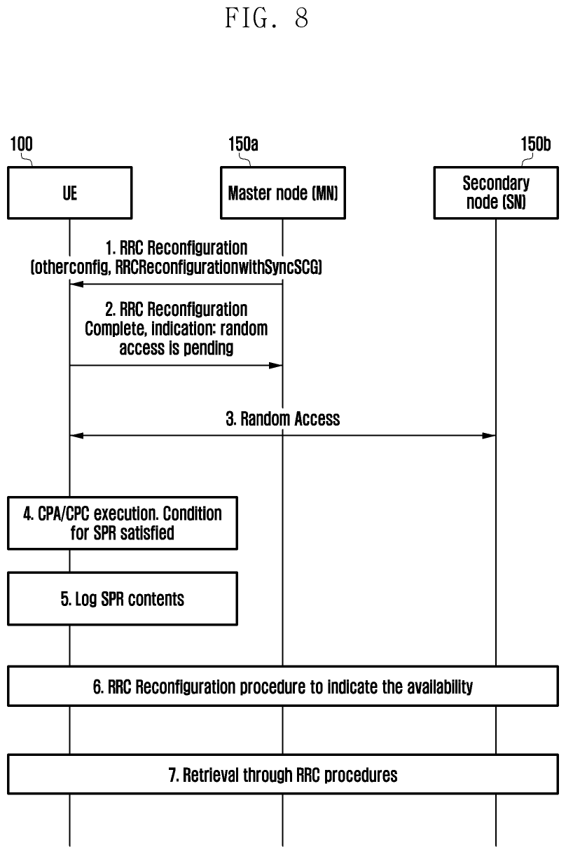

FIG. 8 is an example sequence diagram illustrating SPR handling overwrite issue, according to embodiments as disclosed herein. In an embodiment, the UE (100) logs the successful PSCell Addition information or the successful PSCell change information in the SPR after sending RRC Reconfiguration complete towards the MN (150a) and stores the time (for e.g. UTC time or the like) or the time elapsed after Successful PSCell change or after successful PSCell addition or an indicator like a sequence number when the RRC Reconfiguration complete is send. If the random access towards the SN (150b) fails, the UE (100) may further store the SCGFailure information along with the time when the failure occurred or the time elapsed from failure and the same indicator that is stored in the successful PSCell Addition or the successful PSCell change report.

In an embodiment, the UE (100) sends the RRC message like UE Assistance Information (or any message other than a RRC complete message like the existing messages for availability indicator like RRC Setup complete/RRC Reconfiguration Complete/RRC Resume Complete/RRC Reestablishment complete) to indicate that availability of SPAR and SPCR on logging SPAR/SPCR after the successful RACH on the SN (150b).

In an embodiment, the network entity (150) (e.g., gNB or the like) may configure the UE whether it is allowed to send UE Assistance Information (or any UL message other than complete messages like RRC Setup complete/RRC Reconfiguration Complete/RRC Resume Complete/RRC Reestablishment complete) to indicate the availability of Successful PSCell reports on logging SPR after the successful RACH on the SN (150b). In an embodiment, the UE (100) may store multiple entries for SPR.

In an embodiment, if the UE (100) has initiated Reconfiguration complete (e.g., RRC Reconfiguration complete or RRCConnection Reconfiguration complete) before the random access is successful, it includes a flag which indicates the same. The UE (100) may inform the network entity (150) the order in which RACH and RRC Reconfiguration is performed. The network entity (150) understands that the SPR for the PSCell Addition or PSCell change may be logged by the UE (100) after it has send Reconfiguration complete and takes steps to retrieve the availability, for e.g. by sending a RRC Reconfiguration message or UE Information Request. If the UE (100) receives the UE information request and if there is no SPR available, the UE (100) may not include the SPR in the UE Information Response or may not send the UE Information Response. The UE (100) also may inform the network entity (150) that any threshold for SPR is met and which thresholds have met. For e.g. if T310 or T312 thresholds are met, the UE (100) includes that SPR triggers are met in RRC Reconfiguration complete.

In an embodiment, during the PSCell change or the PSCell addition, if the UE (100) is configured to report SPAR/SPCR, the UE (100) sends Reconfiguration complete message after random access is performed and if the UE (100) is not configured to report the SPAR/SPCR, the UE (100) may send Reconfiguration complete message before random access is performed.

In an embodiment, the UE (100) indicates the availability indicator and SPAR/SPCR to the network entity (150) that configured the UE (100) for the SPAR/SPCR.

An example change according to some of the embodiments in the proposed method is given below:

Reception of an RRCReconfiguration by the UE (100)

### <Some Sections>

1> else if the RRCReconfiguration message was received via SRB1 within the nr-SCG within mrdc-SecondaryCellGroup (UE in NR-DC, mrdc-SecondaryCellGroup was received in RRCReconfiguration or RRCResume via SRB1):
2> if the RRCReconfiguration is applied due to a conditional reconfiguration execution for CPC which is configured via conditionalReconfiguration contained in nr-SCG within mrdc-SecondaryCellGroup:
3> if UE is sending RRC Reconfiguration while random access on SCG is needed and is not completed
4> include pendingSCGRACH and set it to true
3> submit the RRCReconfigurationComplete message via the NR MCG embedded in NR RRC message ULInformationTransferMRDC as specified in clause 5.7.2a.3.
2> if the scg-State is not included in the RRCReconfiguration or RRCResume message containing the RRCReconfiguration message:
3> if reconfigurationWithSync was included in spCellConfig in nr-SCG; or
3> if the SCG was deactivated before the reception of the NR RRC message containing the RRCReconfiguration message and lower layers consider that a Random Access procedure is needed for SCG activation:
4> initiate the Random Access procedure on the PSCell, as specified in TS 38.321;
3> else:
4> the procedure ends;
2> else
3> the procedure ends;

The order in which the UE (100) sends the RRCReconfigurationComplete message and performs the Random Access procedure towards the SCG is left to the UE implementation.

As shown in FIG. 8, At 1, the UE (100) receives the RRC Reconfiguration (including the otherconfig and RRCReconfigurationwithSyncSCG) from the master node (MN) (150a). At 2, the UE (100) sends the RRC Reconfiguration Complete, indication:random access is pending to the master node (MN) (150a). At 3, the random access is performed by the UE (100) and the SN (150b). At 4, the UE (100) performs the CPA/CPC execution and determines that the condition for SPR is satisfied. At 5, the UE (100) logs the SPR contents. At 6, the RRC Reconfiguration procedure indicates the availability among the UE (100), the MN (150a) and the SN (150b). At 7, the retrieval is performed through the RRC procedures.

The various actions, acts, blocks, steps, or the like in the flow charts (200-600) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1.-10. (canceled)

11. A method performed by a user equipment (UE) in a wireless communication system, the method comprising:
receiving, from a base station, first information on a configuration for the UE to report second information on a successful primary secondary cell group (SCG) cell (PSCell) change or addition;
identifying whether an event occurs; and
in case that the event occurs, releasing the first information.

12. The method of claim 11,
wherein the event comprises at least one of initiating a radio resource control (RRC) connection reestablishment procedure, setting contents of a message associated with SCG failure information, multi-radio dual connectivity (MR-DC) release, or initiating an RRC connection resume procedure, and
wherein the first information is configured by at least one of a primary cell (PCell), a PSCell, a source PSCell, or a target PSCell.

13. The method of claim 11, further comprising:
releasing third information on a UE variable, 48 hours after the last second information is added to the third information; and
releasing information on a threshold associated with a T304 timer.

14. The method of claim 11, further comprising:
discarding third information on a UE variable associated with the second information on a successful delivery of a message associated with a UE information response confirmed by lower layers.

15. The method of claim 11, further comprising:
receiving, from the base station, a radio resource control (RRC) reconfiguration message comprising fourth information on a synchronous reconfiguration; and
releasing the first information,
wherein the event comprises whether the RRC reconfiguration message comprises the fourth information.

16. The method of claim 11, further comprising:
transmitting, to the base station, the second information,
wherein the second information comprises at least one of information on a measurement result, information on a cause of a successful PSCell change or addition report, information on an identifier of a source PSCell, information on an identifier of a target PSCell, or information on an elapsed time.

17. A method performed by a base station in a wireless communication system, the method comprising:
identifying first information on a configuration for a user equipment (UE) to report second information on a successful primary secondary cell group (SCG) cell (PSCell) change or addition; and
transmitting, to the UE, the first information,
wherein, in case that an event occurs, the first information is released by the UE.

18. A user equipment (UE) in a wireless communication system, the UE comprising:
a transceiver; and
at least one processor coupled with the transceiver and configured to:
receive, from a base station, first information on a configuration for the UE to report second information on a successful primary secondary cell group (SCG) cell (PSCell) change or addition,
identify whether an event occurs, and
in case that the event occurs, release the first information.

19. The UE of claim 18,
wherein the event comprises at least one of initiating a radio resource control (RRC) connection reestablishment procedure, setting contents of a message associated with SCG failure information, multi-radio dual connectivity (MR-DC) release, or initiating an RRC connection resume procedure, and
wherein the first information is configured by at least one of a primary cell (PCell), a PSCell, a source PSCell, or a target PSCell.

20. The UE of claim 18, wherein the at least one processor is further configured to:
release third information on a UE variable, 48 hours after the last second information is added to the third information, and
release information on a threshold associated with a T304 timer.

21. The UE of claim 18, wherein the at least one processor is further configured to:
discard third information on a UE variable associated with the second information on a successful delivery of a message associated with a UE information response confirmed by lower layers.

22. The UE of claim 18,
wherein the at least one processor is further configured to:
receive, from the base station, a radio resource control (RRC) reconfiguration message comprising fourth information on a synchronous reconfiguration, and
release the first information, and
wherein the event comprises whether the RRC reconfiguration message comprises the fourth information.

23. The UE of claim 18,
wherein the at least one processor is further configured to:
transmit, to the base station, the second information, and
wherein the second information comprises at least one of information on a measurement result, information on a cause of a successful PSCell change or addition report, information on an identifier of a source PSCell, information on an identifier of a target PSCell, or information on an elapsed time.

24. A base station in a wireless communication system, the base station comprising:
a transceiver; and
at least one processor coupled with the transceiver and configured to:
identify first information on a configuration for a user equipment (UE) to report second information on a successful primary secondary cell group (SCG) cell (PSCell) change or addition, and
transmit, to the UE, the first information,
wherein, in case that an event occurs, the first information is released by the UE.

25. The base station of claim 24,
wherein the at least one processor is further configured to:
transmit, to the UE, a radio resource control (RRC) reconfiguration message comprising fourth information on a synchronous reconfiguration, and
receive, from the UE, the second information,
wherein the event comprises at least one of initiating an RRC connection reestablishment procedure, setting contents of a message associated with SCG failure information, multi-radio dual connectivity (MR-DC) release, initiating an RRC connection resume procedure, or whether the RRC reconfiguration message comprises the fourth information,
wherein the first information is configured by at least one of a primary cell (PCell), a PSCell, a source PSCell, or a target PSCell, and
wherein the second information comprises at least one of information on a measurement result, information on a cause of a successful PSCell change or addition report, information on an identifier of a source PSCell, information on an identifier of a target PSCell, or information on an elapsed time.
